(19) United States
(12) Patent Application Publication
(10) Pub. No.: US 2006/0216033 A1
(43) Pub. Date: Sep. 28, 2006

(54) System and method for extending the range of hard-wired electrical systems

(76) Inventor: Norbert E. Yankielun, Lebanon, NH (US)

Correspondence Address: HUMPHREYS ENGINEER CENTER SUPPORT ACTIVITY;ATTN: CEHEC-OC, 7701 TELEGRAPH ROAD, ALEXANDRIA, VA, 22315-3860, US

(21) Appl. No.: 11/086,292

(22) Filed: Mar. 23, 2005

(51) Int. Cl. H04B 10/00

(52) U.S. Cl. 398/140

(57) ABSTRACT

A modification to designs of existing hard-wired electrical and electronic systems that extends the operating reach of these systems or improves signal quality, or both. Conventional hard-wired systems have communicated narrow broadband electrical signals only over electrically conductive media such as copper coaxial cable. A modification to the design using an embodiment of the present invention adds electrical-to-optical and optical-to-electrical transceivers, optical fiber, signal conditions and circulators to existing hard-wired systems to permit transmittal of narrow broadband pulses and FM-CW steps signals over a much longer landline than available for conventional systems. Embodiments of the present invention include sensor systems using RF pulses or FM-CW step signals and time domain reflectometry.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This patent and related ones are available for licensing. Contact Sharon Borland at 703 428-9112 or Phillip Stewart at 601 634-4113.

### BACKGROUND

Scour is a severe problem that results in millions of dollars of damage to infrastructure and contributes to loss of life annually. Scour occurs during high tides, hurricanes, rapid river flow and icing conditions when sediment, including rocks, gravel, sand, and silt are transported by the currents. Scour undermines bridge pier foundations, submarine utility cables and pipelines, and fills in navigational channels. Scour is dynamic. Ablation and deposition can occur during the same high-energy hydrodynamic event, so the worst-case net effect cannot be easily predicted nor monitored in real-time.

Several bridge scour monitoring technologies exist, including patented electromagnetic sensors described in U.S. Pat. No. 6,526,189, Scour Sensor Assembly to Yankielun, Feb. 25, 2003 and incorporated herein by reference; U.S. Pat. No. 5,790,471, Water-Sediment Interface Monitoring System Using Frequency Modulated Continuous Wave, to Yankielun and Zabilansky, Aug. 4, 1998 and incorporated herein by reference; U.S. Pat. No. 5,784,338, Time Domain Reflectometry System for Real-Time Bridge Scour Detection and Monitoring, to Yankielun and Zabilansky, Jul. 21, 1998 and incorporated herein by reference; and a patent application by Yankielun and Zabilansky, U.S. patent application Ser. No. 09/293,781, A Scour Detection and Monitoring Apparatus for Use in Lossy Soils, filed Apr. 19, 1999 and incorporated herein by reference. Other work has been accomplished in this area, e.g., see Yankielun, N. E. and L. Zabilansky, Laboratory Experiments with an FM-CW Reflectometry System for Detecting and Monitoring Bridge Scour in Real-Time, (paper submitted to Canadian Journal of Civil Engineering), 1998; Yankielun, N. E. and L. Zabilansky, Innovative Instrumentation Techniques for Detect and Measuring Effects of Sediment Scour Under Ice, ASCE Water Resources Engineering, pp. 204-209, 1998; Yankielun, N. E. and L. Zabilansky, Laboratory Investigations of a Time Domain Reflectometry System for Real-Time Bridge Scour Detection and Monitoring, Canadian Journal of Civil Engineering, February 2000; Zabilansky, L., Ice Force and Scour Instrumentation for the White River, Vermont, U.S. Army Corps of Engineers ERDC SR 96-6, 1996.

While these Time Domain Reflectometry (TDR) instruments are successful in detecting, monitoring and measuring scour and deposition of sediments, their operational range like that of other hard-wired RF systems, is limited by the effects of bandwidth “dispersion” and amplitude attenuation of the short (narrow), broadband pulse that is applied. In typical installations, the distance between instrumentation and probe has not exceeded 300 meters. For larger bridges, dams and other scour-prone structures and for applications where it is desirable to centralize the instrumentation from several clusters of remote probes, this distance may not be practical.

Current implementations of metallic TDR instruments 300 rely on long lengths of high quality, low-loss coaxial cable 102 to interconnect the above-the-surface TDR instrument with a submerged TDR probe (sensor) 301 typically buried in saturated sediments (not shown separately) such as may occur in a river bottom. The coaxial cable 102 propagates a short broadband pulse 101, i.e., very narrow pulse in the time domain (often on the order of nanoseconds), which implies a wide bandwidth frequency spectrum. A difficulty with transmitting wide bandwidth signals over “coax” is the degradation of the signal due to electrical attenuation and dispersion of the transmitted signal.

Refer to FIG. 1. Attenuation refers to the decrease in signal amplitude (strength) as it propagates down a transmission line 102. FIG. 1 A illustrates the effect of attenuation on a short broadband pulse 101. A strong signal (pulse) 101 applied to one end of a transmission line 102 may appear as a very weak signal 103 at the far end of the transmission line 102 due to the attenuating effects of the cable impedance (resistance and reactance). Even the best copper cable has some resistance, resulting in a voltage drop from input to output of the cable. This voltage drop is uniform for all frequencies comprising a wideband signal. The reactive component of the transmission line, i.e., effects of intrinsic capacitance and inductance of the wire, also contributes to attenuation. However, the losses due to this reactance are frequency dependent, i.e., the individual frequency components of “wideband” signals respond non-uniformly because of this frequency “dependence,” thus the amplitude relationship of the various frequency components of a wideband signal (or a step function having a fast rise time) is not consistent. FIG. 1 B illustrates the effect of this dispersion on a narrow pulse 101, effectively “broadening” the pulse as shown by the wide pulse 104. In frequency-dependent attenuation, the “velocity factor” of the copper cable may vary as a function of the applied frequency(ies), thus changing the phase relationships of the various frequency components that comprise the signal. This is particularly critical with a short, wideband pulse or a sharp rise-time step. Both of these factors (amplitude attenuation and frequency “broadening” or dispersion) contribute to the combined pulse dispersion and attenuation shown in FIG. 1C as the “broadened and attenuated” pulse 105.

Refer to FIG. 2 depicting the effects of dispersion on the ability to resolve spatially close dielectric material boundaries. Specifically referring to FIG. 2 A, the shaded box 200 represents bounded dielectric material. The solid lines 201 A, B represent pulse reflections of the two short wideband pulses 101 originally impressed on the transmission line 102 that communicates with the dielectric material 200. The reflections 201 A, B are typical of those from leading and trailing boundary interfaces of the dielectric material 200 as transmitted over a relatively short transmission line of less than 300 m. Dotted lines 202 A, B represent reflected pulses as might be seen on a display of a TDR 300. The two narrow pulses 201 A, B clearly define boundaries as shown by the pulses 202 A, B that are typical of those displayed on a TDR display 300.

Refer to FIG. 2B. Two somewhat dispersed short wideband pulses 203, 205 that may have been similar to pulses 201 A, B upon initial impression on the transmission line 102 but traverse a greater distance of the transmission line 102 typically still maintain a marginal ability to discern the two boundaries of the dielectric material 200 after transmission over a moderately long transmission line, typically at least about 300 m. The twin peaks of the signals 204, 206 that would typically appear on the TDR display 300 are discernible but the overlap at 210 is considerable.

Refer to FIG. 2C. Two greatly dispersed pulses 203 A, B, typically the pulses 203 and 205 that have traversed a greater length of the transmission line 102, make resolution of material boundaries nearly impossible because the two signals 203 A, 205 A have each now “dispersed” to “reflect” a distorted broad single signal 207 that is typical of what might appear on the TDR display 300.

Dispersion and attenuation affect the signal-to-noise ratio of a system as well as the ability to resolve two pulses adjacent in time. Thus, with long copper transmission lines of 300 m or more on which it is necessary to transmit short, wideband pulses, the ability to temporally resolve the peaks of two adjacent pulses diminishes. Of practical concern is the inability to measure changes in dimension of material that is being monitored by a TDR system if the data need be transmitted more than 300 m.

Thus, what is needed is a system and technique that permits the direct transmission of a short wideband pulse (or step) over distances on the order of at least several kilometers. Preferably, the system employs COTS fiber optic components. The advantage of a fiber optic transmission line is significantly lower signal attenuation rate per unit length than coaxial cable and significantly lower pulse dispersion.

### BRIEF DESCRIPTION OF DRAWINGS

FIG. 1 A depicts only the relative attenuation of a short wideband pulse after passing through a relatively long copper transmission line as would be employed in a prior art system.

FIG. 1 B depicts only the relative dispersion of the pulse of FIG. 1 A after passing through a relatively long copper transmission line as would be employed in a prior art system.

FIG. 1 C depicts both the relative attenuation and the relative dispersion of the pulse of FIG. 1 A after passing through a relatively long copper transmission line as would be employed in a prior art system.

FIG. 2 A depicts two short wideband pulses as initially reflected from a dielectric shape and transmitted on a relatively short copper transmission line to a TDR display and a trace indicating their most likely presentation on the TDR display as would be employed in a prior art system.

FIG. 2 B depicts two short wideband pulses as initially reflected from a dielectric shape and transmitted on a copper transmission line longer than that of FIG. 2 A to a TDR display and a trace indicating their most likely presentation on the TDR display as would be employed in a prior art system.

FIG. 2 C depicts two short wideband pulses as initially reflected from a dielectric shape and transmitted on a copper transmission line longer than that of FIG. 2 B to a TDR display and a trace indicating their most likely presentation on the TDR display as would be employed in a prior art system.

FIG. 3 depicts a prior art embodiment of a TDR system used with a probe.

FIG. 4 A depicts a first embodiment of the present invention as used with a probe.

FIG. 4 B depicts a second embodiment of the present invention as used with a probe.

FIG. 4 B depicts a third embodiment of the present invention as used with a probe.

FIG. 5 depicts a fourth embodiment of the present invention as used with a probe.

FIG. 6 depicts an embodiment of the present invention as used with multiple probes and two multiplexers.

FIG. 7 depicts an embodiment of the present invention that is an alternative to the embodiment of FIG. 6.

FIG. 8 depicts an embodiment of the present invention that is another alternative to the embodiment of FIG. 6.

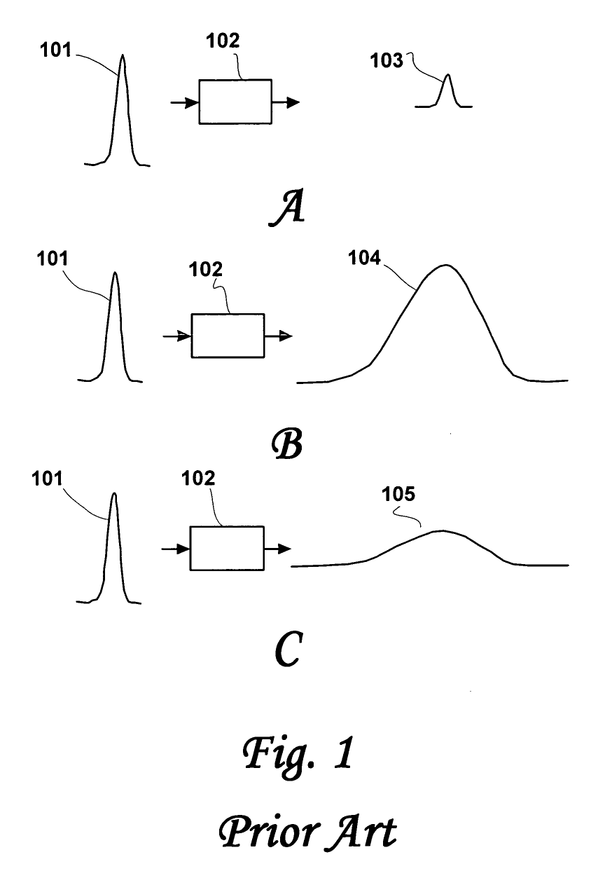

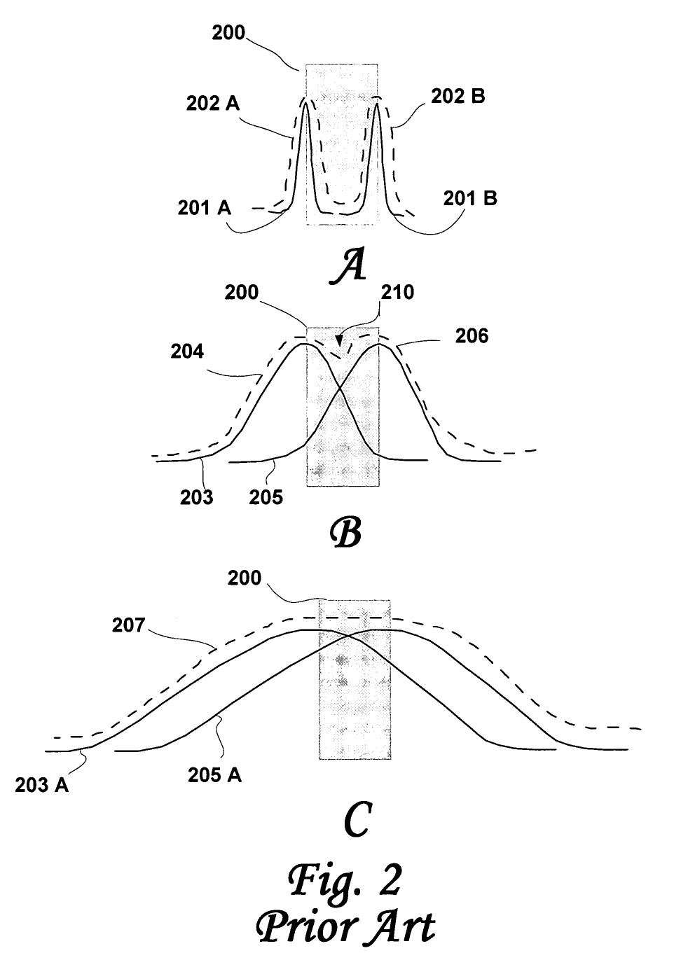

### DETAILED DESCRIPTION

In select embodiments of the present invention, an apparatus extends the operating reach of systems that have conventionally communicated narrow broadband electrical signals only over electrically conductive media. The apparatus comprises: means for converting first electrical signals to optical signals that retain at least one parameter of the first electrical signals; means for transmitting the optical signals, the means for transmitting communicating with the means for converting the first electrical signals; one or more optical fibers connected to the means for transmitting the optical signals; means for receiving the converted optical signals, the means for receiving connected to the optical fiber; means for converting the optical signals to second electrical signals that retain at least one parameter of the first electrical signals; and means for transmitting the second electrical signals, the means for transmitting the second electrical signals connected to the means for converting the optical signals, such that the apparatus permits system operation at a distance greater than conventional systems incorporating only electrically conductive media.

In select embodiments of the present invention, the apparatus is a sensor system. In select embodiments of the present invention, the sensor system incorporates circuitry implementing time domain reflectometry (TDR).

In select embodiments of the present invention, the electrical signals are radio frequency (RF) signals. In select embodiments of the present invention, the RF signals are pulses. In select embodiments of the present invention, the RF signals are FM-CW step signals.

In select embodiments of the present invention, the electrically conductive media is coaxial cable. In select embodiments of the present invention, the means for converting electrical signals to optical signals is one or more electrical-to-optical converter/transceivers. In select embodiments of the present invention, the means for transmitting optical signals is one or more electrical-to-optical converter/transceivers. In select embodiments of the present invention, the means for converting the optical signals to second electrical signals is one or more optical-to-electrical converter/transceivers. In select embodiments of the present invention, the means for transmitting the second electrical signals is one or more optical-to-electrical converter/transceivers.

In select embodiments of the present invention, a method for extending the operating reach of systems that have conventionally communicated narrow broadband electrical signals entirely over electrically conductive media comprises: providing means for converting first electrical signals to optical signals that retain at least one parameter of the first electrical signals; converting the first electrical signals to optical signals; providing means for transmitting the optical signals, the means for transmitting optical signals communicating with the means for converting the first electrical signals; providing one or more optical fibers connected to the means for transmitting the optical signals; transmitting the optical signals over the optical fiber; providing means for receiving the optical signals, the means for receiving the optical signals connected to the optical fiber; receiving the optical signals; providing means for converting the optical signals to second electrical signals that retain one or more parameters of the first electrical signals, the means for converting the optical signals communicating with the means for receiving the optical signals; converting the optical signals to the second electrical signals; providing means for transmitting the second electrical signals, the means for transmitting the second electrical signals communicating with the means for converting the optical signals; and transmitting the second electrical signals, such that the method permits electrical signals to be transmitted at a distance greater than conventional methods employing only electrically conductive media.

In select embodiments of the present invention, the immediately above method is used with a sensor system. In select embodiments of the present invention, the above method is used while implementing time domain reflectometry (TDR) in a sensor system.

In select embodiments of the present invention, the above method implementing TDR in a sensor system is accomplished by employing radio frequency (RF) signals as the electrical signals. In select embodiments of the present invention, the immediately above method employs the RF signals as pulses. In select embodiments of the present invention, the immediately above method employs RF signals as FM-CW step signals.

In select embodiments of the present invention, the immediately above method uses coaxial cable for the electrically conductive media.

In select embodiments of the present invention, the immediately above method employs one electrical-to-optical converter/transceivers as the means for converting the electrical signals to optical signals. In select embodiments of the present invention, the immediately above method employs one or more electrical-to-optical converter/transceivers as the means for transmitting the optical signals. In select embodiments of the present invention, the immediately above method employs one or more optical-to-electrical converter/transceivers as the means for converting the optical signals to second electrical signals. In select embodiments of the present invention, the immediately above method employs one or more optical-to-electrical converter/transceivers as the means for transmitting the second electrical signals.

In select embodiments of the present invention, a method is employed for retaining the characteristics of narrow broadband electrical signals that conventionally are communicated entirely over electrically conductive media. The method comprises: providing means for converting first electrical signals to optical signals that retain at least one parameter of the electrical signals; converting the first electrical signals to the optical signals; providing means for transmitting the optical signals, the means for transmitting the optical signals communicating with the means for converting the first electrical signals; providing one or more optical fibers connected to the means for transmitting the optical signals; transmitting the optical signals over the optical fiber; providing means for receiving the optical signals, the means for receiving the optical signals connected to the optical fiber; receiving the optical signals; providing means for converting the optical signals to second electrical signals that retain one or more parameters of the first electrical signals, the means for converting the optical signals communicating with the means for receiving the optical signals; converting the optical signals to the second electrical signals; providing means for transmitting the second electrical signals, the means for transmitting the second electrical signals communicating with the means for converting the optical signals; and transmitting the second electrical signals, such that the method preserves characteristics of the electrical signals better than conventional methods employing only electrically conductive media.

In select embodiments of the present invention, an apparatus is provided for retaining characteristics of electrical signals that have conventionally been communicated over electrically conductive media in a system, comprising: means for converting first electrical signals to optical signals that retain at least one parameter of the first electrical signals; means for transmitting the optical signals, the means for transmitting the optical signals communicating with the means for converting the first electrical signals; one or more optical fibers connected to the means for transmitting the optical signals; means for receiving the optical signals, the means for receiving the optical signals connected to the optical fiber; means for converting the optical signals to second electrical signals that retain at least one parameter of the first electrical signals, and means for transmitting the second electrical signals, the means for transmitting the second electrical signals communicating with the means for converting the optical signals; such that the apparatus preserves the characteristics of the first electrical signals better than systems not incorporating the apparatus.

In select embodiments of the present invention, a time domain reflectometry (TDR) sensor system is provided. The TDR sensor system employed as an embodiment of the present invention communicates narrow broadband RF signals partially over electrically conductive media and partially over optical fiber and comprises: means for initiating one or more signals on electrically conductive media; means for facilitating simultaneous transmission of the signals and receipt of reflections of the signals, the means for facilitating connected to the electrically conductive media; means for conditioning the signals and reflections, the means for conditioning communicating with the means for facilitating simultaneous transmission; means for impedance matching the signals and reflections, the means for impedance matching communicating with one or more means for facilitating simultaneous transmission; one or more sensors communicating with the means for impedance matching; means for converting first electrical signals to optical signals that retain at least one parameter of the first electrical signals, the means for converting first electrical signals communicating with the means for conditioning; means for transmitting the optical signals, the means for transmitting the optical signals communicating with the means for converting the first electrical signals; one or more optical fibers connected to the means for transmitting the optical signals; means for receiving the optical signals, the means for receiving the optical signals connected to the optical fiber; means for converting the optical signals to second electrical signals that retain at least one parameter of the first electrical signals, the means for converting the optical signals to second electrical signals communicating with the means for receiving the optical signals, and means for transmitting the second electrical signals, the means for transmitting the second electrical signals communicating with the means for converting the optical signals, such that the system operates at a distance greater than conventional systems incorporating only electrically conductive media.

In select embodiments of the TDR sensor system as described above, the means for initiating one or more signals is a TDR instrument.

In select embodiments of the TDR sensor system as described above, the means for initiating one or more signals is a signal generator.

In select embodiments of the TDR sensor system as described above, the means for facilitating simultaneous transmission is a microwave circulator.

In select embodiments of the TDR sensor system as described above, the means for conditioning the signals and reflections is one or more amplifiers

In select embodiments of the TDR sensor system as described above, the means for impedance matching the signals and the reflections is one or more impedance matching transformers.

In select embodiments of the TDR sensor system as described above, the RF signals are pulses. In select embodiments of the TDR sensor system as described above, the RF signals are FM-CW step signals.

In select embodiments of the TDR sensor system as described above, the electrically conductive media is coaxial cable.

In select embodiments of the TDR sensor system as described above, the means for converting the electrical signals to optical signals is one or more electrical-to-optical converter/transceivers. In select embodiments of the TDR sensor system as described above, the means for transmitting the optical signals is one or more electrical-to-optical converter/transceivers.

In select embodiments of the TDR sensor system as described above, the means for converting the optical signals to second electrical signals is one or more optical-to-electrical converter/transceivers. In select embodiments of the TDR sensor system as described above, the means for transmitting the second electrical signals is one or more optical-to-electrical converter/transceivers.

In select embodiments of the TDR sensor system as described above, the system further comprises one or more means for data storage and display. In select embodiments of the TDR sensor system as described above, the data storage and display means is one or more TDR instruments. In select embodiments of the TDR sensor system as described above, the data storage and display means is one or more oscilloscopes.

In select embodiments of the TDR sensor system as described above, the TDR sensor system further comprises one or more multiplexers for multiplexing the RF signals and reflections thereof from multiple sensors.

In select embodiments of the TDR sensor system as described above, the TDR sensor system further comprises one or more lengths of coaxial cable, each length connecting one microwave circulator to a corresponding impedance matching transformer.

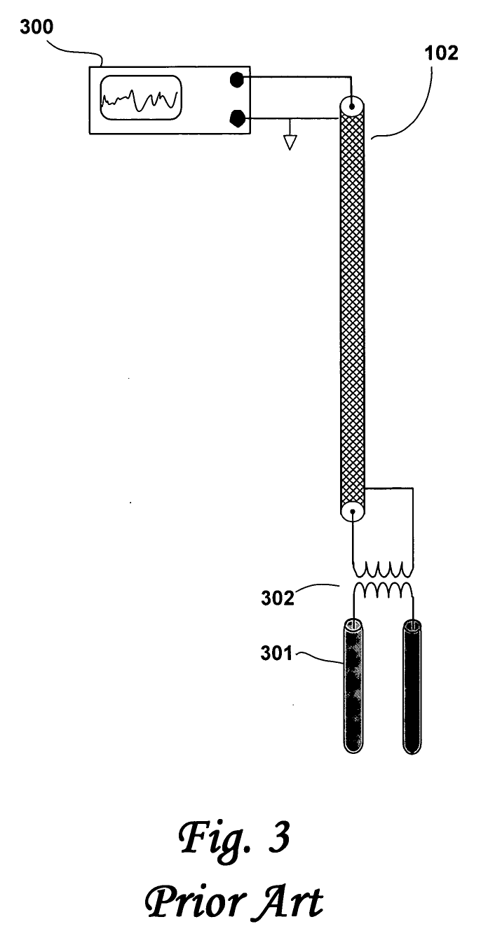

Refer to FIG. 3 depicting a conventional connection of a metallic TDR 300 to a scour sensor probe 301 via coaxial cable 102. The transformer 302 shown between the coaxial cable 102 and probe sensor 301 provides a degree of impedance match between cable 102 and sensor 301, minimizing the magnitude of a reflection at that boundary.

While illustrated and explained in detail here for a metallic short wideband pulse (or fast-rise step pulse) TDR-based system, embodiments of the approach apply to a frequency-modulated continuous wave (FM-CW) reflectometer-based system.

RF component suppliers, such as MINICIRCUITS, MITEQS, and the like, manufacture COTS electronic components, such as amplifiers, voltage-controlled oscillators, and the like, that may be used to build high-resolution FM-CW or pulse-based reflectometers.

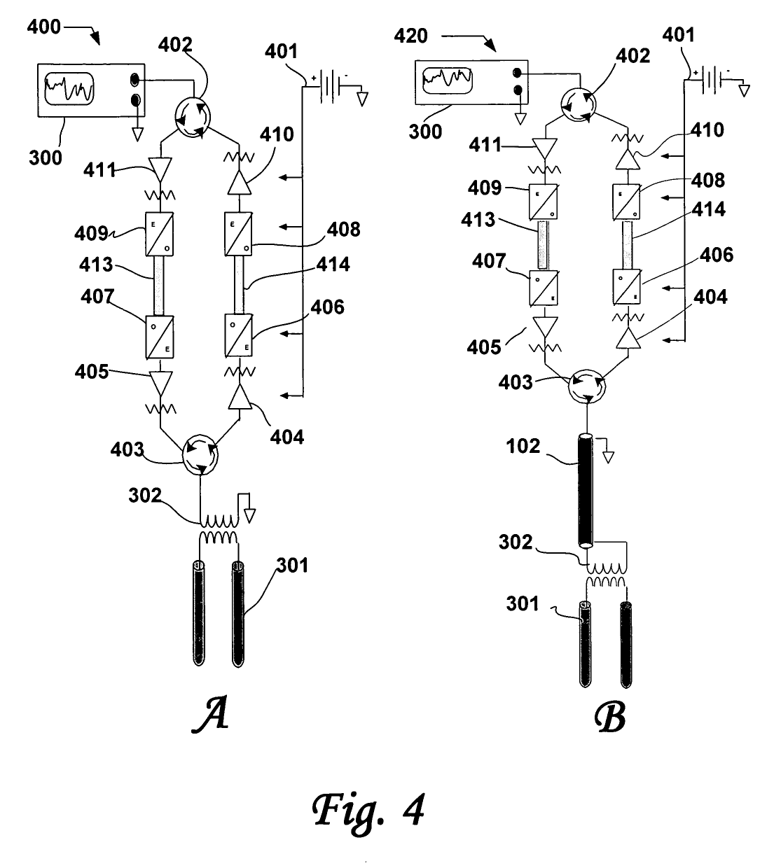

Refer to FIG. 4A depicting an embodiment of the present invention 400 employing a TDR instrument 300 suitable for launching and recovering a short, wideband RF pulse. The RF pulse 101 is generated at the TDR instrument 300 and propagates counter-clockwise around the electrical circulator 402. The pulse exits the circulator 402 and is “conditioned,” e.g., either amplified or attenuated to a specified level at amplifier 411, for input to a first electrical-to-optical converter/transceiver 409 that converts the RF (electrical) signal to a photonic signal that maintains the waveform and bandwidth characteristics of the original RF signal. The resultant photonic signal next propagates through the fiber optic path 413, encountering an optical-to-electrical converter/transceiver 407 in which the original RF pulse 101 is re-created from the photonic signal. The “reconstituted” RF waveform is “conditioned” at amplifier 405, e.g., either amplified or attenuated, as required. The RF pulse 101 is then applied to a second electrical circulator 403, propagating counter-clockwise around the second electrical circulator 403, and exiting to an impedance-matching transformer 302 prior to traveling down the parallel transmission lines constituting the sensor probe 301.

Upon interacting with dielectric boundaries (not shown separately) in the environment surrounding the probe 301, one or more reflections (depending on the composition of the medium in which the probe 301 is inserted) propagate back up the transmission lines of the probe 301. The reflection(s) propagate across the impedance matching transformer 302 and counter-clockwise around the second circulator 403. Once through the second circulator 403 they are conditioned by the amplifier 404 and applied to a second electrical-to-optical converter/transceiver 406 that converts the reflected RF signals to photonic signals that maintain the waveform and bandwidth characteristics of the reflected RF signals. The resultant photonic signal next propagates through the fiber optic path 414, encountering a second optical-to-electrical converter/transceiver 408 in which the reflected RF signals are re-created from the photonic signals. The “reconstituted” reflected RF waveforms are “conditioned” at amplifier 410, e.g., either amplified or attenuated, as required, and input to the first circulator 402. The conditioned reconstituted reflected RF waveforms propagate counter-clockwise through the first circulator 402 and are applied to the input of the TDR 300 where they are displayed, offset in time from an image of the originally transmitted pulse 101. This “offset” represents the round-trip propagation time of the originally transmitted pulse 101 from each of the dielectric boundaries that it reflected from with sufficient “strength” to be recognized by the threshold set by the circuitry of the TDR system 400. That is, the display of the TDR 300 shows all “recognized” reflections from the various impedance changes or mismatches (dielectric boundaries) in the pathways of the TDR system 400 and probes 301.

Each mismatch is displayed as a reflected pulse of diminished amplitude that is displaced in time proportional to the pulse's one-way propagation time plus the return time from the particular mismatch associated with the specific reflection. Selected of these diminished amplitude “reflection” pulses are due to reflections caused by discontinuities in the dielectric material that surrounds the probe 301, e.g., an air/water or water/sediment boundary. The TDR instrument 300 may be “time gated” to display only those reflections from the environment surrounding the probe 301.

Refer to FIG. 4 B depicting another embodiment 420 of the present invention. This embodiment 420 is the same as that shown in FIG. 4 A except for a short length of coaxial cable 102 inserted between the second circulator 403 and the impedance matching transformer 302. The short length of the coaxial cable 102 introduces little attenuation and dispersion to any signal impressed thereon while this embodiment of the present invention facilitates locating the probe 301, e.g., a probe 301 that may be hidden in several feet of sediment on a river bottom.

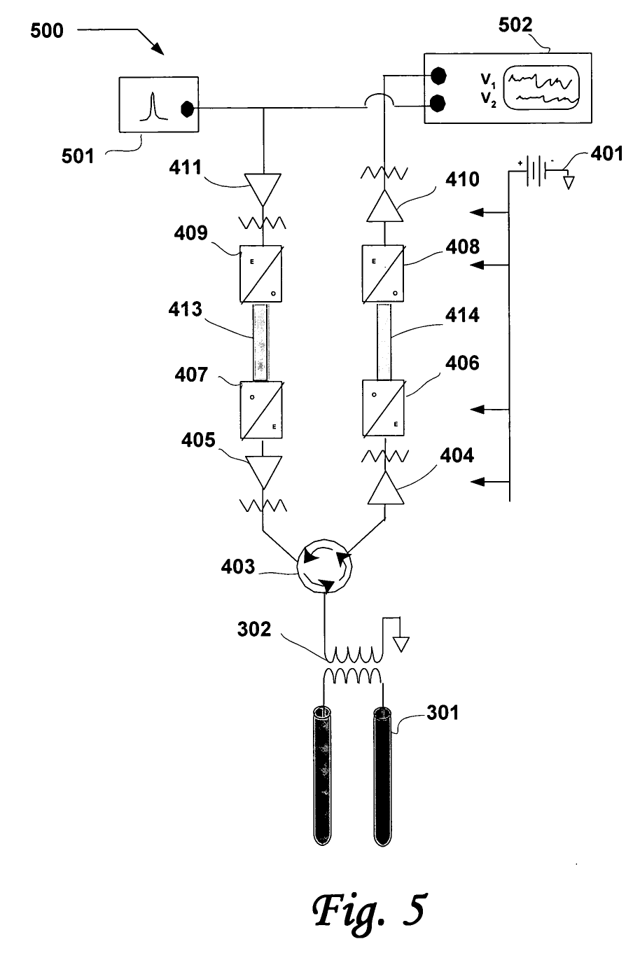

Refer to FIG. 5, depicting a third embodiment 500 of the present invention. Instead of using the TDR instrument 300 of FIGS. 4 A, B to generate and display pulses 101, a short broadband pulse 101 (or fast rise time step) is produced by a signal generator 501. That pulse 101 is applied to the circuit of the embodiment 500 and propagates through the remainder of the circuit, much as in the system version shown in FIGS. 4 A, B. This embodiment 500 displays the reflected pulses on an oscilloscope 502 instead of the display of a TDR instrument 300. FIG. 5 shows the original pulse 101 and reflected pulses (not shown separately) being displayed on two different trace channels, V₁ and V₂, respectively. Alternatively, with some additional electronics, the original pulse 101 and reflected pulses may be displayed on a single channel (not shown separately) of the oscilloscope 502.

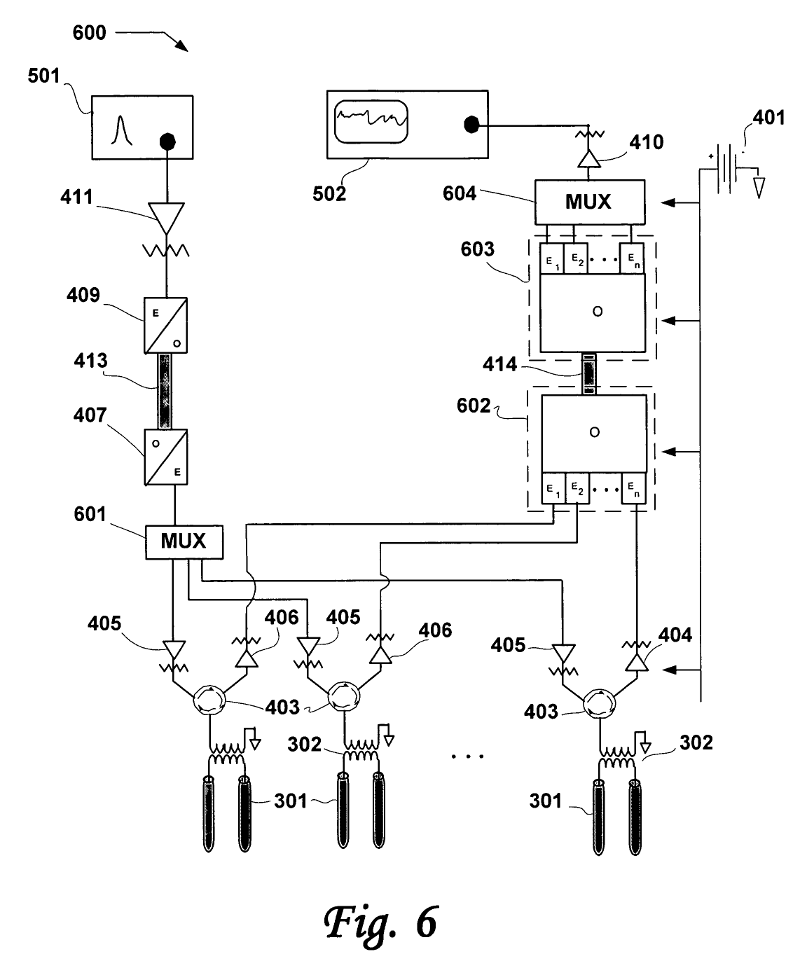

FIG. 6 illustrates another an embodiment 600 of the present invention that multiplexes reflected signals (not shown separately) from several sensor probes 301. A DC power source 401 provides the “copper path” for the electronics needed to operate the sensor probes 301. Similar to the embodiment of FIG. 5, instead of using a conventional TDR instrument 300, a signal generator 501 capable of producing short (narrow pulse width) broadband pulses 101 and an oscilloscope 502 are employed. A single channel optical-electrical converter/transceiver pair 407, 409 provides the pulse 101 simultaneously to all connected sensor probes 301 via a first multiplexer 601. COTS multi-channel fiber optic/electrical converter/transceiver module pairs 602, 603 employ wavelength division multiplexing. The wavelength-multiplexed converter/transceiver pair 602, 603 carries simultaneous responses (reflections) from all probes 301 to the second multiplexer 604 connected to the input of the oscilloscope 502. Reflections from each probe 301 are simultaneously, but individually, propagated through a single path using optical wavelength multiplexing over the fiber optic portion and an electronic multiplexing switch (not shown separately) once the reflected electrical signal is converted first to an optical signal in converter/transceiver 602 and then back to electrical from optical in the converter/transceiver 603. The electronic multiplexer 604 is connected to the multiple outputs of the multi-channel fiber optic/electrical transceiver 603. Responses from individual probes 301 may be displayed on the oscilloscope 502 via selection of the appropriate channel of the multiplexer 604. Alternatively, as shown in FIG. 5, a second oscilloscope channel, V₂, may display the originally transmitted pulse 101 for “time-of-flight” comparison.

As shown in FIGS. 4 A, B, with the addition of appropriate electronics (not shown separately), a TDR instrument 300 may be substituted for the pulse generator 501 and oscilloscope 502 of this embodiment 600.

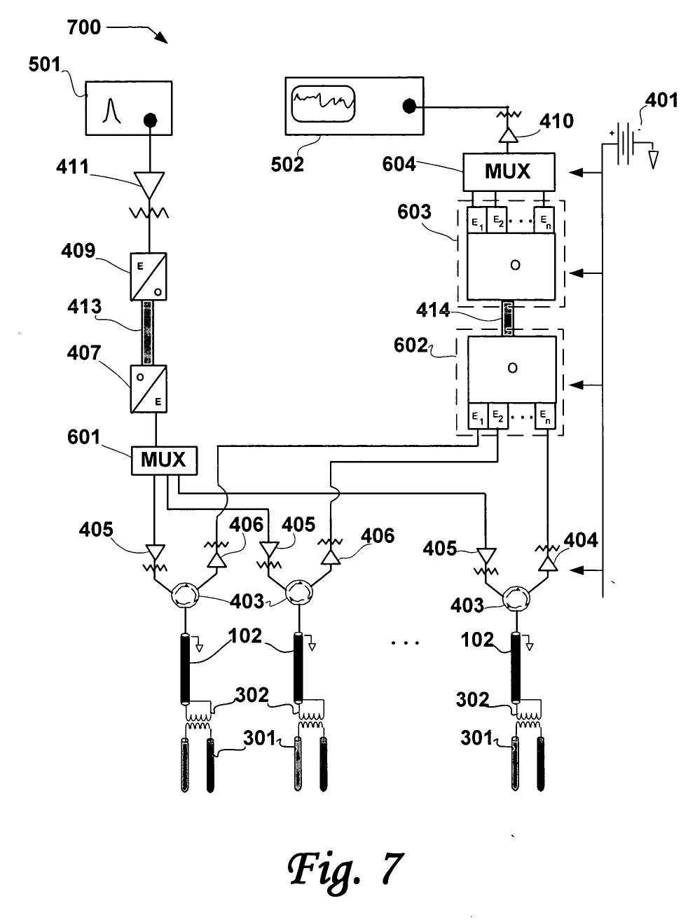

Refer to FIG. 7 illustrating another embodiment 700 of the present invention using lengths of coaxial cable 102 (in a manner similar to FIG. 4 B) inserted between the lower circulators 403 and impedance transformers 302 of multiple probes 301, thus facilitating a localized distribution of probes 301 a short distance (<300 m) from the interconnected fiber optic cables 413, 414.

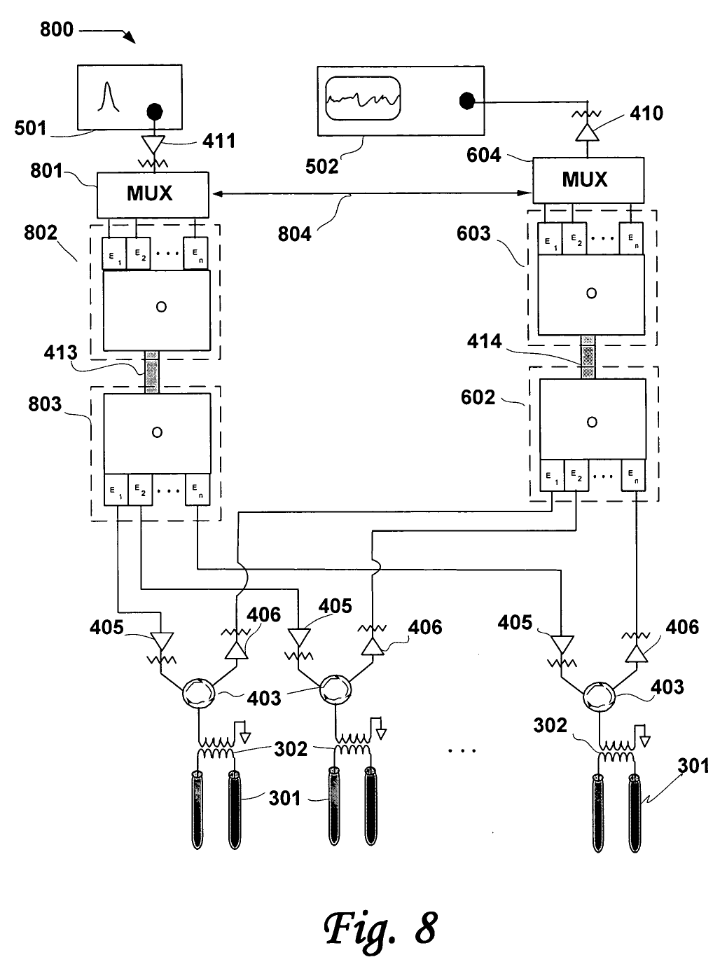

Refer to FIG. 8 illustrating another embodiment 800 of the present invention using a pair 602, 603, 802, 803 of fiber optic-to-electrical (or electrical-to-fiber optic) converter/transceiver pairs. Here, a first electronic multiplexer 801 is used to selectively and sequentially distribute a short broadband pulse 101 to a multi-channel wavelength division multiplexed fiber optic/electronic converter/transceiver pair 802, 803 for selected and sequential distribution to a series of sensor probes 301. The reflected signals (not shown separately) from each probe 301 are selectively and sequentially transmitted through a return path consisting of another wavelength division multiplexed fiber optic transmission pair 602, 603 in a fashion similar to the embodiment 700 of FIG. 7, and distributed to an oscilloscope 502 as required for storage and display, e.g., in a sequential and selective manner that has been pre-specified. The electronic multiplexers 604, 801 are synchronized as indicated by connection path 804.

These examples illustrate using two individual optical fibers 413, 414, one 413 for pulse transmission and a second 414 for reception of the pulse reflection. With appropriate arrangement of electronic components, fiber optic components, and configuration of a wavelength-multiplexing scheme, all signals can be simultaneously passed (in both directions) over a single optical fiber.

In embodiments of the present invention, COTS fiber optic-to-electrical (or electrical-to-fiber optic) converter/transceivers 407, 409, 406, 408 are employed, such as the family of fiber optic links manufactured by MITEQ® CORP. As an example, MITEQ® manufactures a series of fiber optic-to-electrical and electrical-to-fiber optic converter/transceiver pairs 602, 603 intended for RF-to-optic link and optic link-to-RF applications, e.g., a 3-GHz LBL fiber optic link, a 6-GHz SCM fiber optic link, and an 11-GHz MDD fiber optic link. These links each comprise a miniature matched fiber optic-to-electrical and electrical-to-fiber optic converter/transceiver pair 602, 603 capable of supporting transmission RF-to-fiber optic and fiber optic-to-RF communications at multi-GHz bandwidths. Since a typical FM-CW signal (step or pulse) used in reflectometry is a short broadband RF signal, it is readily communicated using these components.

### EXAMPLE

In a practical application, the “land-based” components (such as a pulse generator 501 or TDR instrument 300; oscilloscope 502; amplifiers 410, 411; circulator 402; multiplexers 604, 801; certain converter/transceivers 408, 409, 603, 802, and the like) are connected by armored fiber optic cables (not shown separately) and a copper conductor pair (not shown separately) to supply ground and a DC voltage to electronic components that comprise the submerged part of the system (such as the probes 301, the impedance matching transformers 302; amplifiers 405, 406; circulators 403; multiplexer 601; certain converter/transceivers 406, 407, 602, 803, and the like. Depending on how deep the probes are installed below the water surface, some electronics may be installed on-land but remotely from the display. These include everything but the impedance matching transformers 302 and the probes 301 themselves, especially if the coaxial cable 102 is inserted between the impedance matching transformers 302 and the circulators 403. The below-the-water TDR sensor probe electronics may be installed as taught in the patents incorporated herein by reference.

There are several advantages to the implementation of a fiber optic-based range extender for a metallic TDR scour detection and monitoring system. The distance from a sensor to instrumentation can be extended from less than 300 meters to several (or perhaps several tens of) kilometers. The dispersive effects, i.e., frequency “broadening,” on broadband pulse are nearly eliminated. Attenuation effects on a short (narrow) pulse are nearly eliminated. Multiple sensors may be monitored using one system and an electronic multiplexer.

Thus, implementation of embodiments of the present invention addresses the following challenge. Select embodiments of the present invention permit installation of a probe array on large structures with all broadband signal paths routed to a single “environmentally benign” remote location for most of the instrumentation. For typical systems employing short broadband RF pulses, select embodiments of the present invention extend the maximum “hard-wired” range between installed sensors and the remote instrumentation from 300 m to several kilometers, if not tens of kilometers. In select embodiments of the present invention, expensive instrumentation may be shared by multiple sensor probes.

Numerous industrial, commercial, and military instrumentation and measurement systems may employ embodiments of the present invention. Applications include measurement and monitoring of change in materials and material depth, bridge scour, navigation channel sedimentation, dredging spoils stability, and infrastructure, as well as geophysics and engineering investigations.

Accordingly, all such modifications are intended to be included within the scope of this invention as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

The abstract of the disclosure is provided to comply with the rules requiring an abstract that will allow a searcher to quickly ascertain the subject matter of the technical disclosure of any patent issued from this disclosure. It is submitted with the understanding that it will not be used to interpret or limit the scope or meaning of the claims. 37 CFR § 1.72(b). Any advantages and benefits described may not apply to all embodiments of the invention.

I claim:

1. An apparatus for extending the operating reach of systems that have conventionally communicated narrow broadband electrical signals only over electrically conductive media, comprising:
means for converting first said electrical signals to optical signals that retain at least one parameter of said electrical signals;
means for transmitting said optical signals, said means for transmitting in operable communication with said means for converting said first electrical signals;
at least one optical fiber in operable communication with at least said means for transmitting said optical signals;
means for receiving said converted optical signals, said means for receiving in operable communication with said optical fiber;
means for converting said optical signals to second said electrical signals that retain at least one parameter of said first electrical signals, and
means for transmitting said second electrical signals, said means for transmitting said second electrical signals in operable communication with said means for converting said optical signals;
wherein said apparatus permits system operation at a distance greater than conventional systems incorporating only electrically conductive media.

2. The apparatus of claim 1 in which said system is a sensor system.

3. The apparatus of claim 2 in which said sensor system incorporates circuitry implementing time domain reflectometry (TDR).

4. The apparatus of claim 1 in which said electrical signals are radio frequency (RF) signals.

5. The apparatus of claim 4 in which said RF signals are pulses.

6. The apparatus of claim 4 in which said RF signals are FM-CW step signals.

7. The apparatus of claim 1 in which said electrically conductive media is coaxial cable.

8. The apparatus of claim 1 in which said means for converting said electrical signals to optical signals is at least one electrical-to-optical converter/transceiver.

9. The apparatus of claim 8 in which said means for transmitting said optical signals is at least one said electrical-to-optical converter/transceiver.

10. The apparatus of claim 1 in which said means for converting said optical signals to second said electrical signals is at least one optical-to-electrical converter/transceiver.

11. The apparatus of claim 10 in which said means for transmitting said second electrical signals is at least one said optical-to-electrical converter/transceiver.

12. A method for extending the operating reach of systems that have conventionally communicated narrow broadband electrical signals entirely over electrically conductive media, comprising:
providing means for converting first said electrical signals to optical signals that retain at least one parameter of said electrical signals;
converting said first electrical signals to said optical signals;
providing means for transmitting said optical signals, said means for transmitting said optical signals in operable communication with said means for converting said first electrical signals;
providing at least one optical fiber, said optical fiber in operable communication with said means for transmitting said optical signals;
transmitting said optical signals over said optical fiber;
providing means for receiving said optical signals, said means for receiving said optical signals in operable communication with said optical fiber;
receiving said optical signals;
providing means for converting said optical signals to second said electrical signals that retain at least one parameter of said first electrical signals, said means for converting said optical signals in operable communication with said means for receiving said optical signals;
converting said optical signals to said second electrical signals;
providing means for transmitting said second electrical signals, said means for transmitting said second electrical signals in operable communication with said means for converting said optical signals; and
transmitting said second electrical signals,
wherein said method permits said electrical signals to be transmitted at a distance greater than conventional methods employing only electrically conductive media.

13. The method of claim 12 providing said system as a sensor system.

14. The method of claim 13 implementing time domain reflectometry (TDR) in said sensor system.

15. The method of claim 12 providing said electrical signals as radio frequency (RF) signals.

16. The method of claim 15 providing said RF signals as pulses.

17. The method of claim 15 providing said RF signals as FM-CW step signals.

18. The method of claim 12 providing said electrically conductive media as coaxial cable.

19. The method of claim 12 providing said means for converting said electrical signals to optical signals as at least one electrical-to-optical converter/transceiver.

20. The method of claim 19 providing said means for transmitting said optical signals as at least one said electrical-to-optical converter/transceiver.

21. The method of claim 12 providing said means for converting said optical signals to second said electrical signals as at least one optical-to-electrical converter/transceiver.

22. The method of claim 21 providing said means for transmitting said second electrical signals as at least one said optical-to-electrical converter/transceiver.

23. A method for retaining the characteristics of narrow broadband electrical signals that have been conventionally communicated entirely over electrically conductive media, comprising:
providing means for converting first said electrical signals to optical signals that retain at least one parameter of said electrical signals;
converting said first electrical signals to said optical signals;
providing means for transmitting said optical signals, said means for transmitting said optical signals in operable communication with said means for converting said first electrical signals;
providing at least one optical fiber, said optical fiber in operable communication with said means for transmitting said optical signals;
transmitting said optical signals over said optical fiber;
providing means for receiving said optical signals, said means for receiving said optical signals in operable communication with said optical fiber;
receiving said optical signals;
providing means for converting said optical signals to second said electrical signals that retain at least one parameter of said first electrical signals, said means for converting said optical signals in operable communication with said means for receiving said optical signals;
converting said optical signals to said second electrical signals;
providing means for transmitting said second electrical signals, said means for transmitting said second electrical signals in operable communication with said means for converting said optical signals; and
transmitting said second electrical signals,
wherein said method preserves characteristics of said electrical signals better than conventional methods employing only electrically conductive media.

24. An apparatus for retaining characteristics of electrical signals that have been conventionally communicated entirely over electrically conductive media in a system, comprising:
means for converting first said electrical signals to optical signals that retain at least one parameter of said electrical signals;
means for transmitting said optical signals, said means for transmitting in operable communication with said means for converting said first electrical signals;
at least one optical fiber in operable communication with at least said means for transmitting said optical signals;
means for receiving said converted optical signals, said means for receiving in operable communication with said optical fiber;
means for converting said optical signals to second said electrical signals that retain at least one parameter of said first electrical signals, and
means for transmitting said second electrical signals, said means for transmitting said second electrical signals in operable communication with said means for converting said optical signals;
wherein said apparatus preserves the characteristics of said electrical signals better than systems not incorporating said apparatus.

25. A time domain reflectometry (TDR) sensor system that communicates narrow broadband RF signals partially over electrically conductive media and partially over optical fiber, comprising:
means for initiating at least one signal on said electrically conductive media;
means for facilitating simultaneous transmission of said signals and receipt of reflections of said signals, said means for facilitating in operable communication with said electrically conductive media;
means for conditioning said signals and said reflections, said means for conditioning in operable communication with said means for facilitating simultaneous transmission;
means for impedance matching said signals and said reflections, said means for impedance matching in operable communication with at least one said means for facilitating simultaneous transmission;
at least one sensor in operable communication with said means for impedance matching;
means for converting first said electrical signals to optical signals that retain at least one parameter of said electrical signals, said means for converting first said electrical signals in operable communication with said means for conditioning;
means for transmitting said optical signals, said means for transmitting said optical signals in operable communication with said means for converting said first electrical signals;
at least one optical fiber in operable communication with at least said means for transmitting said optical signals;
means for receiving said converted optical signals, said means for receiving said optical signals in operable communication with said optical fiber;
means for converting said optical signals to second said electrical signals that retain at least one parameter of said first electrical signals, said means for converting said optical signals to second said electrical signals in operable communication with said means for receiving said optical signals, and
means for transmitting said second electrical signals, said means for transmitting said second electrical signals in operable communication with said means for converting said optical signals,
wherein said system is able to operate at a distance greater than conventional systems incorporating only electrically conductive media.

26. The system of claim 25 in which said means for initiating at least one signal is a TDR instrument.

27. The system of claim 25 in which said means for initiating at least one signal is a signal generator.

28. The system of claim 25 in which said means for facilitating simultaneous transmission is a microwave circulator.

29. The system of claim 25 in which said means for conditioning said signals and said reflections is at least one amplifier.

30. The system of claim 25 in which said means for impedance matching said signals and said reflections is at least one impedance matching transformer.

31. The system of claim 25 in which said RF signals are pulses.

32. The system of claim 25 in which said RF signals are FM-CW step signals.

33. The system of claim 25 in which said electrically conductive media is coaxial cable.

34. The system of claim 25 in which said means for converting said electrical signals to optical signals is at least one electrical-to-optical converter/transceiver.

35. The system of claim 34 in which said means for transmitting said optical signals is at least one said electrical-to-optical converter/transceiver.

36. The system of claim 25 in which said means for converting said optical signals to second said electrical signals is at least one optical-to-electrical converter/transceiver.

37. The system of claim 36 in which said means for transmitting said second electrical signals is at least one said optical-to-electrical converter/transceiver.

38. The system of claim 25 further comprising at least one data storage and display means.

39. The system of claim 38 in which said data storage and display means is at least one TDR instrument.

40. The system of claim 38 in which said data storage and display means is at least one oscilloscope.

41. The system of claim 25 further comprising at least one multiplexer for multiplexing said RF signals and reflections thereof from multiple sensors.

42. The system of claim 25 further comprising at least one length of coaxial cable, each said length connecting one said microwave circulator to a corresponding said impedance matching transformer.

43. A method for operating a time domain reflectometry (TDR) sensor system communicating narrow broadband RF signals partially over electrically conductive media and partially over optical fiber, comprising:
providing means for initiating at least one said RF signal on said electrically conductive media;
transmitting said RF signal on said electrically conductive media;
providing means for facilitating simultaneous transmission of said signals and receipt of reflections of said signals, said means for facilitating in operable communication with said electrically conductive media;
providing means for conditioning said signals and said reflections, said means for conditioning in operable communication with at least said means for facilitating simultaneous transmission;
providing means for impedance matching said signals and said reflections, said means for impedance matching in operable communication with at least one said means for facilitating simultaneous transmission;
providing at least one sensor in operable communication with said means for impedance matching;
providing means for converting first said electrical signals to optical signals that retain at least one parameter of said electrical signals, said means for converting first said electrical signals in operable communication with said means for conditioning;
providing means for transmitting said optical signals, said means for transmitting said optical signals in operable communication with said means for converting said first electrical signals;
providing at least one optical fiber in operable communication with at least said means for transmitting said optical signals;
providing means for receiving said optical signals, said means for receiving said optical signals in operable communication with at least said optical fiber;
providing means for converting said optical signals to second said electrical signals that retain at least one parameter of said first electrical signals, said means for converting said optical signals to second said electrical signals in operable communication with said means for receiving said optical signals, and
providing means for transmitting said second electrical signals, said means for transmitting said second electrical signals in operable communication with said means for converting said optical signals,
wherein said method facilitates operation at a distance greater than that available to conventional TDR sensor systems incorporating only electrically conductive media.

44. The method of claim 43 further providing at least one data storage and display means.

45. The method of claim 43 further providing said data storage and display means as at least one TDR instrument.

46. The method of claim 43 further providing said display and storage means as at least one oscilloscope.

47. The method of claim 43 further providing multiple sensors and at least one multiplexer for multiplexing said RF signals and reflections thereof from said multiple sensors.
